(19) United States
(12) Patent Application Publication
(10) Pub. No.: US 2018/0282103 A1
(43) Pub. Date: Oct. 4, 2018

(54) PRINTING SYSTEM HAVING IC TAG PROCESSING FUNCTION

(71) Applicant: Oki Data Corporation, Tokyo (JP)

(72) Inventor: Naoki SATO, Tokyo (JP)

(73) Assignee: Oki Data Corporation, Tokyo (JP)

(21) Appl. No.: 15/923,099

(22) Filed: Mar. 16, 2018

(30) Foreign Application Priority Data
Mar. 29, 2017 (JP) 2017-064257

(51) Int. Cl. G03G 15/00; B65H 35/00; B65H 43/00; B65H 20/02

(52) U.S. Cl. CPC B65H 35/0093; G03G 15/6523; G03G 15/5029; B65H 20/02; B65H 35/0086; B65H 43/00; G03G 15/652

(57) ABSTRACT

A printing system having an IC tag processing function includes a first medium conveyance section and a second medium conveyance section that convey a medium including a plurality of medium sheets each having an IC tag, an IC tag processor that performs reading and writing processing for the IC tag, a printing section that performs printing on the medium, a slack generator that permits generation of slack of the medium, a calculator that calculates a substantial conveyance speed of the medium by the first medium conveyance section, on a basis of a length of a single medium sheet having the IC tag and time needed by the IC tag processor to process the IC tag of the single medium sheet, and a speed determinator that sets a conveyance speed of the medium by the second medium conveyance section to a speed slower than the substantial conveyance speed.

### BACKGROUND OF THE INVENTION

### 1. Field of the Invention

The present invention relates to a printing system having a function of performing processing for an IC tag (reading, writing of information, etc.).

### 2. Description of the Related Art

Conventionally, a system having a reading and writing section having an RFID (radio frequency identification) antenna and a printing section has been developed. Continuous form paper having RFID tags (IC tags) is conveyed, and the reading and writing section performs reading and writing of information for the RFID tags, and the printing section prints marks and the like on the continuous form paper.

In the system, the processing in the reading and writing section and the printing in the printing section is performed without stopping the conveyance of the continuous form paper, in order to improve the processing efficiency (for example, Japanese Patent Application Publication No. 2015-179397 (see paragraphs 0027 to 0030, for example)).

However, the conventional systems stop the conveyance of the continuous form paper if a predetermined number of errors occur in succession. It is possible that the conveyance is stopped while a part of the continuous form paper remains in the printing section, and it interferes with the improvement of the throughput. Especially, in a case where the printing section uses electrophotography, it is possible that a printing failure occurs due to an interruption of the electrophotographic process.

### SUMMARY OF THE INVENTION

The present invention is made to solve the problem described above, and it is an object of the present invention to provide a printing system having an IC tag processing function that can perform processing for an IC tag on a medium without stopping the conveyance of the medium in a printing section.

A printing system having an IC tag processing function according to the present invention includes a first medium conveyance section that conveys a medium including a plurality of medium sheets each having an IC tag along a first conveyance path; a second medium conveyance section that conveys the medium that has been conveyed along the first conveyance path, along a second conveyance path; an IC tag processor that performs reading and writing processing for the IC tag on the first conveyance path; a printing section that performs printing on the medium on the second conveyance path; a slack generator disposed between the first conveyance path and the second conveyance path, the slack generator permitting generation of slack of the medium; a calculator that calculates a substantial conveyance speed of the medium by the first medium conveyance section, on a basis of a length of a single medium sheet having the IC tag, first time needed by the first medium conveyance section to convey the single medium sheet having the IC tag, and second time needed by the IC tag processor to process the IC tag of the single medium sheet; and a speed determinator that sets a conveyance speed of the medium by the second medium conveyance section to a speed slower than the substantial conveyance speed calculated by the calculator.

In the present invention, the substantial conveyance speed by the first medium conveyance section is calculated on the basis of the length of the single medium sheet having the IC tag, the time needed to convey the single medium sheet having the IC tag, and the time needed to process the IC tag of the single medium sheet by the IC tag processor. The medium conveyance speed by the second medium conveyance section is set to the value slower than the substantial conveyance speed. Difference in the conveyance speed between the first conveyance path and the second conveyance path is accommodated by the slack of the medium provided by the slack generator. This allows the IC tag processor to perform the processing without stopping the conveyance of the medium on the second conveyance path (including the printing section). Consequently, the occurrence of printing failures can be suppressed.

### BRIEF DESCRIPTION OF THE DRAWINGS

In the attached drawings:

FIG. 1 is a diagram showing the configuration of a printing system having an IC tag processing function in a first embodiment;

FIG. 2A is a perspective view showing a medium used in the first embodiment, and FIG. 2B is a view showing an example of an information label attached to a roll core of the medium;

FIG. 3 is a schematic diagram showing an example of the configuration of the printing section;

FIG. 4 is a timing diagram showing a medium conveyance speed on a first conveyance path;

FIG. 5 is a block diagram showing a control system of the printing system having the IC tag processing function in the first embodiment;

FIG. 6 is a flowchart illustrating the operation of the printing system having the IC tag processing function in the first embodiment;

FIG. 7 is a block diagram showing a control system of a printing system having an IC tag processing function in a second embodiment; and

FIG. 8 is a flowchart illustrating the operation of the printing system having the IC tag processing function in the second embodiment.

### DETAILED DESCRIPTION OF THE INVENTION

Further scope of applicability of the present invention will become apparent from the detailed description given hereinafter. However, it should be understood that the detailed description and specific examples, while indicating preferred embodiments of the invention, are given by way of illustration only, since various changes and modifications will become apparent to those skilled in the art from the detailed description.

### First Embodiment

### (Configuration of Printing System Having IC Tag Processing Function)

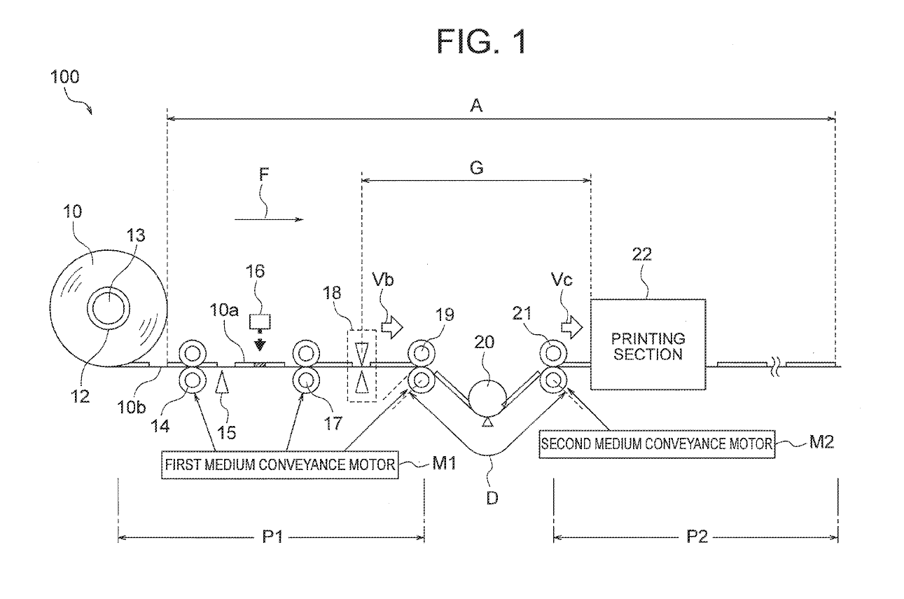

FIG. 1 is a diagram showing the configuration of a printing system having an IC tag processing function (hereafter printing system) 100 in a first embodiment of the present invention. The printing system 100 includes a read/write section 16 that performs reading and writing (i.e., read/write processing) of information for an IC tag 10a included in a medium 10 and a printing section 22 that performs printing on the medium 10. Hereafter, the read/write processing and the printing is referred to as a printing operation.

The printing system 100 includes a roll spindle 13 as a holding section that holds the medium 10, which is a roll of paper, rotatably. The medium 10 is not limited to the roll paper and may be continuous form paper such as fanfold paper.

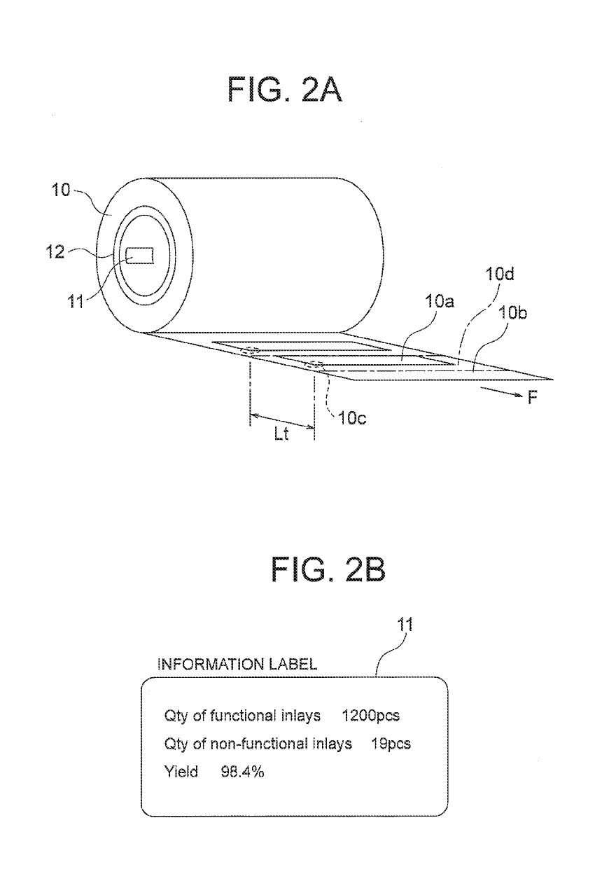

FIG. 2A is a perspective view showing the configuration of the medium 10. The medium 10 has a mount 10b and IC tags 10a stuck on the surface of the mount 10b. The medium 10 includes a plurality of medium sheets 10d each having an IC tag 10a. The IC tags 10a here are RFID (radio frequency identification) tags. The IC tag 10a has an RFID chip and an antenna formed on a film (in other words, an inlay formed on the paper label). The RFID chip of the IC tag 10a stores information. The IC tag 10a here is the RFID tag, although the IC tag 10a is not limited to the RFID tag and may also be a contact-type IC tag. The medium 10 is wound on a cylindrical roll core 12.

The IC tags 10a are disposed at regular intervals in the longitudinal direction of the medium 10. On the back face (on the face opposite to the face on which the IC tags 10a are formed) of the medium 10, cue marks 10c (also referred to as black marks) indicating the positions of the IC tags 10a are formed, as indicated by dotted lines in FIG. 2A. Here, the cue mark 10c is disposed in a position corresponding to the front end of the IC tag 10a in the direction in which the IC tag 10a is conveyed and one end in the width direction of the IC tag 10a, on the back face of the medium 10. The cue mark 10c is not limited to the mark described here but may be any type of mark that allows the position of the IC tag 10a to be detected (IC tag detection mark).

FIG. 2B is a view showing an example of an information label 11 attached to the roll core 12 of the medium 10. The information label 11 is stuck on the inner circumferential surface of the core roll 12. The information label 11 is created on the basis of the results of measurement performed when the medium 10 is produced. The information label 11 indicates the number N of the IC tags 10a included in the single medium 10 (1200 pieces in the shown example), and the number of defective tags among them (19 pieces in the shown example), and a yield rate (98.4% in the shown example). The quotient of the number of the defective tags divided by the number of the IC tags 10a included in the medium 10 is a medium failure rate E1 (1.6%, for example).

Referring to FIG. 1 again, the printing system 100 includes a first roller 14, a second roller 17, and a third roller 19 that draw out the medium 10 wound on the roll spindle 13 and convey the medium 10. The first roller 14, the second roller 17, and the third roller 19 are respectively pairs of rollers pressing against each other across the conveyance path of the medium 10. The first roller 14, the second roller 17, and the third roller 19 are disposed in that order from the left (the side of the roll spindle 13) to the right in the figure.

The first roller 14, the second roller 17, and the third roller 19 are rotated by a first medium conveyance motor M1, at the same speed of rotation (circumferential speed) and with the same timing. The conveyance path of the medium 10 from the roll spindle 13 to the third roller 19 is referred to as an upstream conveyance path (first conveyance path) P1. The first roller 14, the second roller 17, the third roller 19, and the first medium conveyance motor M1 constitute a first medium conveyance section that conveys the medium 10 along the upstream conveyance path P1.

A cue mark detector 15 is disposed downstream of the first roller 14 in the conveyance direction (represented by an arrow F) of the medium 10. The cue mark detector 15 here is disposed to face the back face of the medium 10 and detects the cue mark 10c, which is shown in FIG. 2A. Detection of the cue mark 10c by the cue mark detector 15 makes it possible to detect a length Lt of a single medium sheet 10d having the IC tag 10a and the position of the IC tag 10a in the conveyance direction.

Although the cue mark 10c on the back face of the medium 10 is detected here by the cue mark detector 15, the configuration is not limited as such. For example, a light emitting section and a light receiving section may be disposed to put the medium 10 between them. In this case, the front end of the IC tag 10a in the conveyance direction can be detected from difference between the amount of light received by the light receiving section in a case where light emitted from the light emitting section passes through the mount 10b and then enters the light receiving section, and the amount of light received by the light receiving section in a case where the light passes through both the mount 10b and the IC tag 10a and then enters the light receiving section.

A read/write section 16 as an IC tag processor is disposed downstream of the cue mark detector 15 in the conveyance direction of the medium 10. The read/write section 16 performs the processing for the IC tag 10a. The read/write section 16 includes an RFID antenna for communication with the IC tag 10a, reads information stored in the RFID chip of the IC tag 10a, and writes information into the RFID chip of the IC tag 10a.

Although the read/write section 16 here both reads and writes information for the IC tag 10a, the read/write section 16 may also be a section that only reads the information.

A cutter section 18 is disposed between the second roller 17 and the third roller 19. The cutter section 18 cuts the medium 10 at intervals of a print length A depending on print data. The print length A is also referred to as a cut length.

A slack generator 20 is disposed downstream of the third roller 19 in the conveyance direction of the medium 10, and a fourth roller 21 is disposed further downstream of the slack generator 20. The conveyance path of the medium 10 on the downstream side of the fourth roller will be referred to as a downstream conveyance path (second conveyance path) P2. The slack generator 20 is disposed between the upstream conveyance path P1 and the downstream conveyance path P2. The printing section 22 is disposed on the downstream conveyance path P2.

The slack generator 20 is a part for permitting slack in the medium 10. The slack generator 20 here includes a guide roller 20a disposed between the third roller 19 and the fourth roller 21 and is configured to hold the medium 10 in a roundabout way between the third roller 19 and the fourth roller 21. The amount of the slack of the medium 10 in the slack generator 20 is optional. The slack generator 20 may have any configuration that permits the slack in the medium 10.

The fourth roller 21 is rotated by a second medium conveyance motor M2, which differs from the drive source for the upstream rollers 14, 17, 19, and conveys the medium 10 along the downstream conveyance path P2. A conveyance speed of the medium 10 on the upstream conveyance path P1 by the first medium conveyance motor M1 and a conveyance speed of the medium 10 on the downstream conveyance path P2 by the second medium conveyance motor M2 can be set to different velocities.

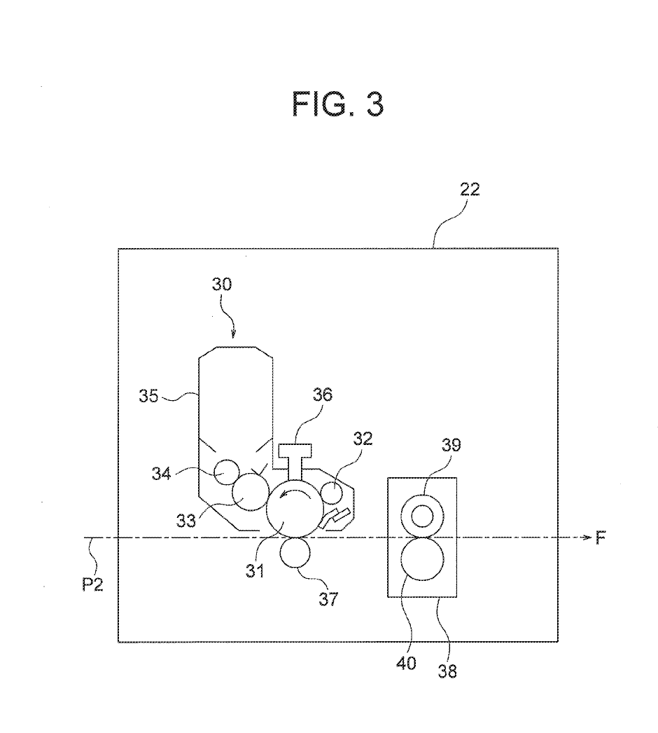

FIG. 3 is a schematic diagram showing an example of configuration of the printing section 22 configured as an electrophotographic printing section. The printing section 22 includes a process unit 30 which forms a toner image (developer image) and transfers the toner image to the medium 10 and a fixing device 38 which fixes the toner image onto the medium 10.

The process unit 30 includes a photosensitive drum 31 as an image carrier, a charging roller 32 as a charging member for uniformly charging the surface (outer circumferential surface) of the photosensitive drum 31, a print head 36 as an exposure device for forming an electrostatic latent image by irradiating the surface of the photosensitive drum 31 with light, a developing roller 33 as a developer carrier for developing the electrostatic latent image with toner (developer), a supply roller 34 as a supplying member for supplying the toner to the developing roller 33, and a toner cartridge 35 as a developer storage body for supplying the developing roller 33 and the supply roller 34 with the toner.

A transfer roller 37, as a transfer member, is disposed to be in contact with the photosensitive drum 31 across the conveyance path of the medium 10. When the medium 10 conveyed along the downstream conveyance path P2 passes a transfer nip between the photosensitive drum 31 and the transfer roller 37, the toner image on the photosensitive drum 31 is transferred to the medium 10 due to the transfer voltage applied to the transfer roller 37.

The fixing device 38 includes a fixing roller 39 and a pressure roller 40 disposed to be in contact with each other across the conveyance path of the medium 10. When the medium 10 which has passed the transfer nip as described above passes a fixing nip between the fixing roller 39 and the pressure roller 40, heat and pressure is applied to the toner image, and the toner image is fixed onto the medium 10.

The photosensitive drum 31 and the fixing roller 39 are rotated by the power transmitted from the second medium conveyance motor M2 (FIG. 1). A conveyance speed (i.e. print speed Vc) at which the medium 10 passes through the printing section 22 is the same as the conveyance speed of the medium 10 due to the fourth roller 21 rotated by the second medium conveyance motor M2.

The printing section 22 is not limited to the one using electrophotography and may also be the one using the inkjet method, for example.

In this printing system 100, the conveyance speed (i.e. print speed Vc) of the medium 10 on the downstream conveyance path P2 is set to a slower speed than a substantial conveyance speed Vb of the medium 10 on the upstream conveyance path P1, as described later.

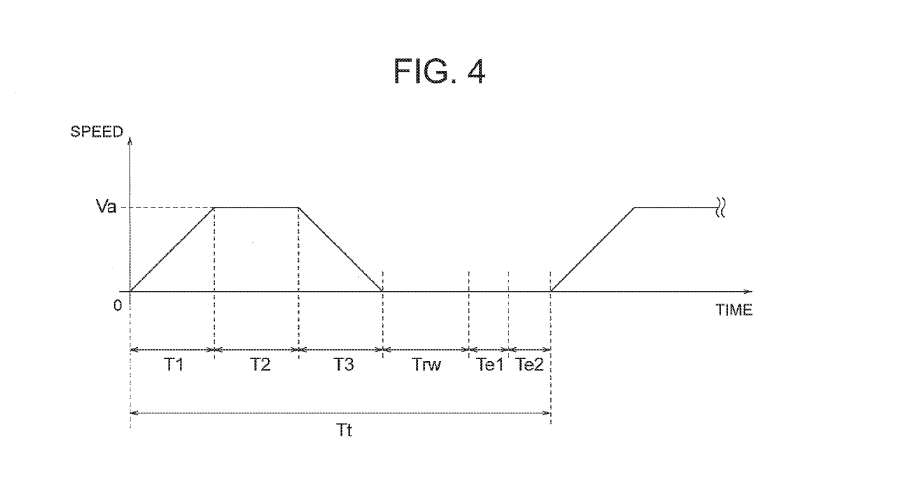

Now, a description of the substantial conveyance speed Vb will be given. FIG. 4 is a timing diagram for illustrating the conveyance speed of the medium 10 on the upstream conveyance path P1. In FIG. 4, the vertical axis shows speed, and the horizontal axis shows time.

In FIG. 4, time Tt is time needed to process a single IC tag 10a. This time Tt is the sum of acceleration time T1, constant speed duration time T2, deceleration time T3, read/write time Trw, medium-failure-rate-based time equivalent Te1, and read/write-error-occurrence-rate-based time equivalent Te2.

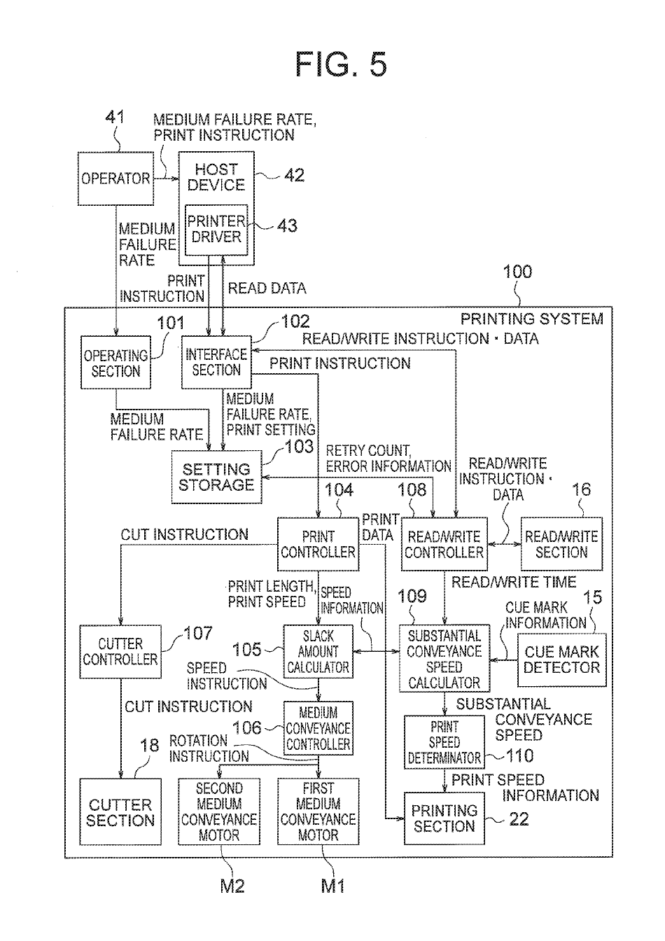

The acceleration time T1 is time from when the first medium conveyance motor M1 starts rotation until when it accelerates to a predetermined speed Va (feed speed). The speed Va is determined in consideration of, for example, the weight and outer diameter of the medium 10 (roll paper) and the capability of the first medium conveyance motor M1. This speed Va is determined beforehand and stored in a medium conveyance controller 106 (FIG. 5), which will be described later.

The deceleration time T3 is time from the state in which the medium 10 is being conveyed at the speed Va until the medium 10 is stopped to perform the read/write processing. The read/write processing for the IC tag 10a is performed in a state in which the medium 10 is stopped. The constant speed duration time T2 is time during which the speed Va is maintained between the acceleration time T1 and the deceleration time T3 and is determined according to the length of the single medium sheet 10d having the IC tag 10a.

The read/write time Trw is time needed for the read/write section 16 to read information from the IC tag 10a and write information to the IC tag 10a. The read/write time Trw is 0.5 seconds, for example, although it is not limited as such.

The medium-failure-rate-based time equivalent Te1 is a time equivalent of the medium failure rate E1 (for example, when the yield rate is 98.4%, the medium failure rate is 1.6%) shown on the information label 11 (FIG. 2B) attached to the core roll 12 of the medium 10, and the medium failure rate E1 is entered into a host device 42 or an operating section 101 (FIG. 5) by an operator.

Since the medium failure rate E1 shown on the information label 11 is the failure rate of the IC tags 10a included in the medium 10 (roll paper), the medium failure rate E1 needs to be divided by the number N of IC tags 10a included in the medium 10 (hereafter tag count) to obtain the failure rate per IC tag 10a.

In this printing system 100, a retry count R (e.g., 3) is set for a case where reading and writing by the read/write section 16 is unsuccessful. Time needed for the read/write processing by the read/write section 16 increases as the retry count R increases, and thus the retry count R also needs to be considered.

The medium-failure-rate-based time equivalent Te1 is calculated from the medium failure rate E1, the read/write time Trw, the retry count R, and the tag count N, by the following expression (1).

Te1=(E1×Trw×R)/N (1)

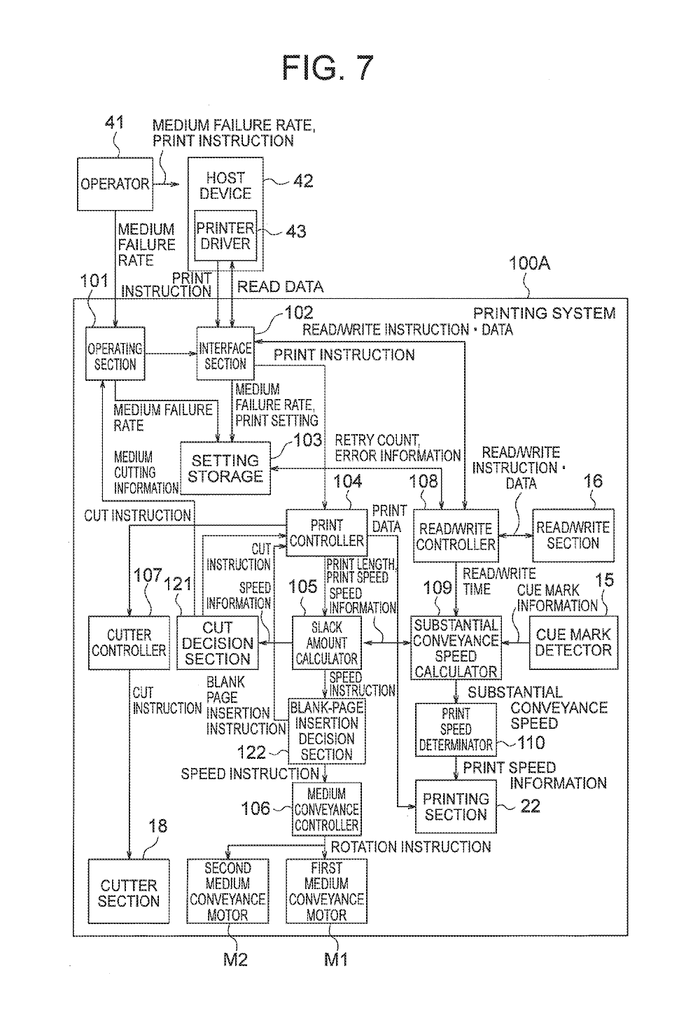

It has been described here that the operator inputs the medium failure rate E1 on the basis of the information label 11, but the setting storage 103 (FIG. 7) of the printing system 100 stores a default medium failure rate E1. If the operator does not input the medium failure rate E1, the default medium failure rate E1 is used. The default failure rate depends on the type of the medium 10, and is around 5%, for example.

The read/write-error-occurrence-rate-based time equivalent Te2 is a time equivalent of a read/write error occurrence rate E2, which depends on the compatibility or the like between the read/write section 16 and the IC tag 10a, for example. The read/write error occurrence rate E2 is determined beforehand from an experiment or the like and is stored as a default value in the setting storage 103 (FIG. 7). The default read/write error occurrence rate is around 5%, for example. The read/write error occurrence rate stored in the setting storage 103 may also be updated on the basis of the rate of an error occurring in the printing system 100.

The read/write error occurrence rate E2 is determined for each medium 10, and in order to obtain the read/write error occurrence rate per IC tag 10a, the read/write error occurrence rate E2 needs to be divided by the tag count N. Time needed for the read/write processing in the read/write section 16 increases as the retry count R described above increases, and thus this retry count R also needs to be considered.

The read/write-error-occurrence-rate-based time equivalent Te2 is calculated from the read/write error occurrence rate E2, the read/write time Trw, the retry count R, and the tag count N, by the following expression (2).

Te2=(E2×Trw×R)/N (2)

The sum of the acceleration time T1, the constant speed duration time T2, the deceleration time T3, the read/write time Trw, the medium-failure-rate-based time equivalent Te1, and the read/write-error-occurrence-rate-based time equivalent Te2 described above is the time Tt needed to process the single IC tag 10a.

The cue mark 10c (FIG. 2A) on the medium 10 is detected by the cue mark detector 15, the length (hereafter tag length) Lt of the single medium sheet 10d having the IC tag 10a is detected, as described above. Therefore, by dividing the tag length Lt by the time Tt needed to process the single IC tag 10a, the substantial conveyance speed Vb (=Lt/Tt) can be calculated.

The default medium failure rate E1 (e.g., 5%) is set higher than a common medium failure rate E1 (1.6% in the example shown in FIG. 2A). Consequently, the medium failure rate E1 becomes lower and the medium-failure-rate-based time equivalent Te1 becomes smaller when the operator inputs the medium failure rate E1 on the information label 11 than when the default medium failure rate E1 is used. As a result, the substantial conveyance speed Vb becomes faster, and the throughput improves.

This printing system 100 sets the conveyance speed (i.e. print speed Vc) of the medium 10 on the downstream conveyance path P2 to a speed slower than the substantial conveyance speed Vb on the upstream conveyance path P1 calculated from time Tt needed to process the single IC tag 10a. This allows the read/write processing for the IC tag 10a to be performed without stopping the conveyance of the medium 10 on the downstream conveyance path P2.

### (Control System)

A control system of the printing system 100 will next be described. FIG. 5 is a block diagram showing the control system of the printing system 100. This printing system 100 is connected to a host device 42 such as a personal computer, for example. The host device 42 includes a printer driver 43 and can send a print instruction (including a read/write instruction) and write data (write information) to the printing system 100, by an operator 41's operation.

The operator 41 inputs the medium failure rate E1 (e.g., 1.6%) based on the information label 11 and the number (tag count) N of IC tags 10a included in the medium 10, to the host device 42.

The printing system 100 includes the operating section 101, an interface section 102, the setting storage 103, a print controller 104, a slack amount calculator 105, the medium conveyance controller 106, a cutter controller 107, a read/write controller 108, a substantial conveyance speed calculator 109 as a calculation section, and a print speed determinator 110 as a speed determination section.

Among the sections given above, the print controller 104, the slack amount calculator 105, the medium conveyance controller 106, the cutter controller 107, the substantial conveyance speed calculator 109, and the print speed determinator 110 can be configured by a common control unit (such as a CPU). The read/write controller 108 can be configured by an independent control unit (such as a CPU). The setting storage 103 can be configured by a storage such as a memory.

The operating section 101 includes an input section, such as a keyboard or a touch panel which accepts the operation by the operator 41, and a display section. The operator 41 can input the medium failure rate E1 and the tag count N to the printing system 100, instead of inputting them to the host device 42.

The interface section 102 receives the print instruction (including the read/write instruction) from the host device 42. If the operator 41 inputs the medium failure rate E1 and the tag count N based on the information label 11 to the host device 42, the interface section 102 receives the medium failure rate E1 and the tag count N from the host device 42 and sends them to the setting storage 103.

In response to the read/write instruction from the host device 42, the interface section 102 sends data (read data) read by the read/write section 16 from the IC tag 10a to the host device 42.

The setting storage 103 is a storage which stores settings related to the read/write processing by the read/write section 16 and the printing by the printing section 22. The setting storage 103 stores a print setting (including a setting related to the read/write processing) included in the print instruction received from the host device 42 through the interface section 102.

The setting storage 103 stores the default medium failure rate E1, the default read/write error occurrence rate E2, and the retry count R described above. In addition, the setting storage 103 stores the medium failure rate E1 and the tag count N based on the information label 11, input by the operator 41 from the operating section 101 or the host device 42. The setting storage 103 sends the stored information to the read/write controller 108.

The print controller 104 sends print data to the printing section 22 and sends a cut instruction to the cutter controller 107, according to the print instruction received from the host device 42 through the interface section 102. In addition, the print controller 104 sends the print length A and the print speed Vc included in the print instruction sent from the host device 42, to the slack amount calculator 105.

The slack amount calculator 105 determines whether the slack generator 20 needs to generate the slack of the medium 10 and calculates the slack amount. If the print length A of the medium 10 is longer than a distance G from the cutter section 18 to the printing section 22 (referred to as the cutter-section-to-printing-section distance), the front end of the medium 10 is entering the printing section 22 when the cutter section 18 cuts the medium 10. Cutting the medium 10 by the cutter section 18 requires a certain period of time, during which the medium 10 needs to be stopped. Accordingly, in order to eliminate the need for stopping the medium 10 by the printing section 22 at the timing of cutting the medium 10, the slack generator 20 slackens the medium 10 by the time Tc (referred to as cutting time) needed to cut the medium 10 by the cutter section 18.

The slack amount is set to a value that is equal to or greater than a value obtained by multiplying the cutting time Tc by the print speed Vc (i.e. Tc×Vc). While the cutter section 18 is cutting the medium 10, the rotation of the first medium conveyance motor M1 (i.e. the rotation of the upstream rollers 14, 17, 19) is stopped, and the rotation of the second medium conveyance motor M2 (i.e. the rotation of the fourth roller 21) is continued, so that the printing section 22 continues printing while the slack amount of the medium 10 in the slack generator 20 is being decreased gradually.

The slack amount calculator 105 always (or periodically) detects the slack amount of the medium 10 in the slack generator 20. For example, the slack amount may be calculated from the difference between the conveyance speed by the first medium conveyance motor M1 and the conveyance speed by the second medium conveyance motor M2, or the slack generator 20 may have a measurement section that measures the slack amount of the medium 10.

The slack amount calculator 105 sends the print speed Vc sent from the print controller 104 as a speed instruction to the medium conveyance controller 106 and the substantial conveyance speed calculator 109.

The read/write instruction and the write data received from the host device 42 through the interface section 102 are sent to the read/write controller (IC tag processing controller) 108. The medium failure rate E1, the read/write error occurrence rate E2, the retry count R, and the tag count N are also sent to the read/write controller 108 from the setting storage 103. As for the medium failure rate E1, if the operator 41 inputs the medium failure rate E1, the input value is sent; if the operator 41 does not input the medium failure rate E1, the default value is sent.

The read/write controller 108 sends the read/write instruction and the write data to the read/write section 16. In response to the read/write instruction, the read/write section 16 reads the information of the IC tag 10a included in the medium 10 or writes information on the IC tag 10a. The information (read data) read by the read/write section 16 is sent to the read/write controller 108 and sent further through the interface section 102 to the host device 42.

The read/write controller 108 also calculates the read/write time Trw on the basis of the read/write data amount (i.e. the amount of information to be written or read) per IC tag 10a and sends the read/write time Trw to the substantial conveyance speed calculator 109. Since the amount of information to be read from the IC tag 10a (read data amount) is unknown before it is read, the read/write time Trw is calculated on the assumption that the amount of information to be read is equivalent to the amount of information to be written (write data amount).

The read/write controller 108 also sends the medium failure rate E1, the read/write error occurrence rate E2, the retry count R, and the tag count N sent from the setting storage 103 to the substantial conveyance speed calculator 109.

To the substantial conveyance speed calculator 109, the print speed Vc based on the print instruction is sent from the slack amount calculator 105, the read/write time Trw, the medium failure rate E1, the read/write error occurrence rate E2, the retry count R, and the tag count N are sent from the read/write controller 108, and a detection signal (cue mark information) is sent from the cue mark detector 15.

The substantial conveyance speed calculator 109 calculates the medium-failure-rate-based time equivalent Te1 and the read/write-error-occurrence-rate-based time equivalent Te2 by using expressions (1) and (2) given above, on the basis of the read/write time Trw, the medium failure rate E1, the read/write error occurrence rate E2, the retry count R, and the tag count N.

The substantial conveyance speed calculator 109 also calculates the tag length Lt on the basis of the cue mark information sent from the cue mark detector 15. On the basis of this tag length Lt, the constant speed duration time T2 (FIG. 4) of the first medium conveyance motor M1 is calculated.

Further, the constant speed duration time T2 calculated here, the acceleration time T1 and deceleration time T3 determined beforehand, the read/write time Trw sent from the read/write controller 108, and the time equivalents Te1, Te2 calculated by using expressions (1) and (2) are added up to obtain the total time Tt (FIG. 4).

The substantial conveyance speed calculator 109 obtains the substantial conveyance speed Vb (=Lt/Tt) by dividing the tag length Lt calculated on the basis of the cue mark information by the total time Tt.

The substantial conveyance speed calculator 109 sends the substantial conveyance speed Vb calculated as described above, together with the print speed Vc included in the print instruction sent from the read/write controller 108, to the print speed determinator 110. Since the constant speed duration time T2, the read/write time Trw, and the time equivalents Te1, Te2 (information concerning conveyance timings) are used for conveyance control by the medium conveyance controller 106, they are sent from the substantial conveyance speed calculator 109 through the slack amount calculator 105 to the medium conveyance controller 106.

The print speed determinator 110 compares the substantial conveyance speed Vb sent from the substantial conveyance speed calculator 109 and the print speed Vc based on the print instruction sent from the slack amount calculator 105, and determines whether the print speed Vc is slower than the substantial conveyance speed Vb.

If the print speed Vc is higher than or equal to the substantial conveyance speed Vb, the print speed determinator 110 changes the print speed Vc so that the print speed Vc becomes slower than the substantial conveyance speed Vb. The print speed Vc is preferred to be slower than the substantial conveyance speed Vb and to be as close as possible to the substantial conveyance speed Vb (for example, to be slower than the substantial conveyance speed Vb by about 1%).

The print speed determinator 110 sends the print speed Vc determined as described above, to the medium conveyance controller 106 and the printing section 22.

The medium conveyance controller 106 sends a rotation instruction to the first medium conveyance motor M1 and the second medium conveyance motor M2 on the basis of the information sent from the slack amount calculator 105, the substantial conveyance speed calculator 109, and the print speed determinator 110, to control the conveyance of the medium 10.

Namely, the medium conveyance controller 106 controls the rotation of the first medium conveyance motor M1 and controls the conveyance of the medium 10 by the upstream rollers 14, 17, 19 on the basis of the slack amount and the conveyance timing information (constant speed duration time T2, read/write time Trw, and time equivalents Te1 and Te2) sent from the slack amount calculator 105.

The medium conveyance controller 106 also controls the rotation of the second medium conveyance motor M2 and controls the conveyance of the medium 10 by the fourth roller 21 (and the photosensitive drum 31 and the fixing roller 39 of the printing section 22) on the basis of the slack amount sent from the slack amount calculator 105 and the print speed Vc sent from the print speed determinator 110.

The cutter controller 107 drives the cutter section 18 on the basis of the cut instruction from the print controller 104. The cutter section 18 cuts the medium 10 by the control of the cutter controller 107.

Incidentally, the tag length L and the constant speed duration time T2 here are determined on the basis of the result of detection by the cue mark detector 15. Accordingly, it is preferred that the medium 10 is provisionally conveyed for cue mark detection by the cue mark detector 15 before the printing operation is started.

### (Operation of Printing System)

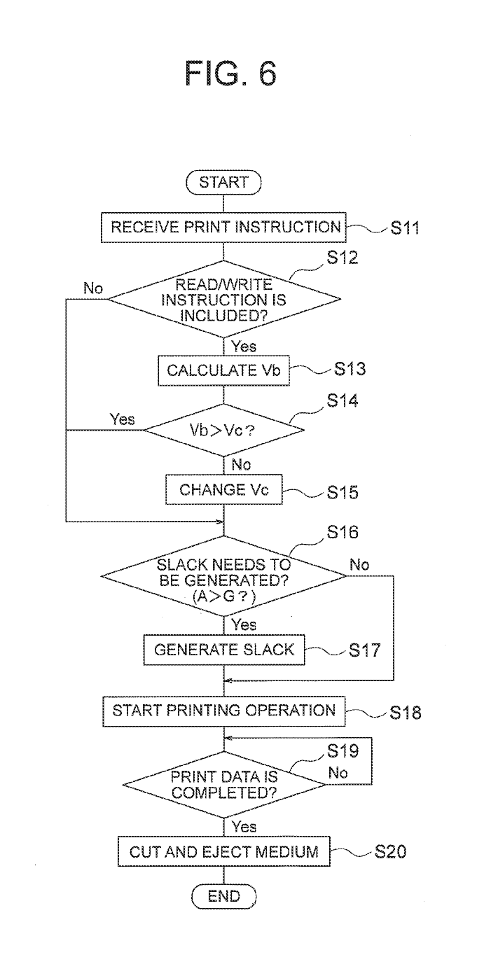

The operation of the printing system 100 will next be described. FIG. 6 is a flowchart illustrating the operation of the printing system 100. The print controller 104 of the printing system 100 receives the print instruction from the host device 42 (step S11) and determines whether the print instruction includes the read/write instruction (step S12).

If the print instruction includes the read/write instruction, the processing proceeds to step S13. If the print instruction includes no read/write instruction, the processing proceeds to step S16. Since the printing system 100 is configured to perform the printing on ordinary paper and the like as well as the medium 10 having the IC tag 10a, the determination step (step S12) is provided.

In step S13, the substantial conveyance speed calculator 109 calculates the substantial conveyance speed Vb (step S13). Namely, the substantial conveyance speed calculator 109 calculates the medium-failure-rate-based time equivalent Te1 and the read/write-error-occurrence-rate-based time equivalent Te2 by using expression (1) and expression (2) given above, on the basis of the read/write time Trw calculated by the read/write controller 108, and the medium failure rate E1, the read/write error occurrence rate E2, the retry count R, and the tag count N received from the setting storage 103 through the read/write controller 108.

Then, the acceleration time T1, the constant speed duration time T2, the deceleration time T3, the read/write time Trw, the time equivalents Te1, Te2 are added up to obtain the total time Tt, and by dividing the tag length Lt calculated from the cue mark information by the total time Tt, the substantial conveyance speed Vb (=Lt/Tt) is obtained.

Next, the print speed determinator 110 compares the substantial conveyance speed Vb calculated in step S13 and the print speed Vc based on the print instruction sent from the host device 42 (step S14). If the print speed Vc is slower than the substantial conveyance speed Vb, the processing proceeds directly to step S16.

If the print speed Vc is higher than or equal to the substantial conveyance speed Vb, the print speed Vc is changed to a speed that is slower than the substantial conveyance speed Vb and is as close as possible to the substantial conveyance speed Vb (for example, a speed slower than the substantial conveyance speed Vb by about 1%) in step 15, and then the processing proceeds to step S16.

In step S16, the slack amount calculator 105 determines whether the slack needs to be generated. Specifically, the print length A of the medium 10 and the cutter-section-to-printing-section distance G are compared. If the print length A of the medium 10 is smaller than or equal to the cutter-section-to-printing-section distance G, no slack needs to be generated, and the processing proceeds to step S18. If the print length A of the medium 10 is longer than the cutter-section-to-printing-section distance G, the slack needs to be generated, and the processing proceeds to step S17.

In step S17, the medium conveyance controller 106 rotates the first medium conveyance motor M1 while stopping the second medium conveyance motor M2, and thereby the slack of the medium 10 is generated. The slack amount is set to a value that is equal to or greater than a value obtained by multiplying the time needed to cut the medium 10 by the cutter section 18 (cutting time) Tc by the print speed Vc (Tc×Vc), as described above.

Then, the printing operation which includes the read/write processing and the printing is started (step S18). Namely, the medium conveyance controller 106 controls the first medium conveyance motor M1 to advance the medium 10 by the length of the single medium sheet 10d having the IC tag 10a and then stop the medium 10 in a stop-and-go manner on the upstream conveyance path P1. The read/write controller 108 controls the read/write section 16 to perform the read/write processing (reading and writing of information) for the IC tag 10a while the medium 10 is stopping. The medium conveyance controller 106 controls also the second medium conveyance motor M2 to convey the medium 10 at the print speed Vc on the downstream conveyance path P2. The print controller 104 controls the printing section 22 to print the toner image on the surface of the medium 10 advancing at the print speed Vc.

This printing operation is repeated until the read/write processing and the printing of all the print data sent from the host device 42 is completed (step S19).

When the printing operation is completed, the cutter section 18 cuts the medium 10 (step S20). If the print length A is longer than the cutter-section-to-printing-section distance G, the slack has been generated in the medium 10 as described above, and thus the medium 10 is cut by the cutter section 18 while the slack of the medium 10 by the slack generator 20 is being decreased gradually by continuing the rotation of the second medium conveyance motor M2 (i.e. continuing the printing by the printing section 22) while the rotation of the first medium conveyance motor M1 is stopped.

After the medium 10 is cut by the cutter section 18, the medium 10 is conveyed and ejected by the fourth roller 21, and the photosensitive drum 31 and the fixing roller 39 of the printing section 22, that are rotated by the second medium conveyance motor M2.

### (Effects of the First Embodiment)

As has been described above, the printing system 100 in the first embodiment of the present invention includes the first medium conveyance section (the first medium conveyance motor M1 and the upper rollers 14, 17, 19) that conveys the medium 10 along the upstream conveyance path P1, the second medium conveyance section (the second medium conveyance motor M2 and the fourth roller 21) that conveys the medium 10 along the downstream conveyance path P2, the read/write section 16 (IC tag processor) that performs the processing for the IC tag 10a on the upstream conveyance path P1, the printing section 22 that prints the medium 10 on the downstream conveyance path P2, and the slack generator 20 provided between the upstream conveyance path P1 and the downstream conveyance path P2. On the basis of the length of the single medium sheet 10d having the IC tag 10a (tag length Lt) included in the medium 10, the time (T1, T2, T3) needed to convey the single medium sheet 10d having the IC tag 10a, and the time needed to process the IC tag 10a of the single medium sheet 10d by the read/write section 16 (read/write time Trw), the substantial conveyance speed Vb on the upstream conveyance path P1 is calculated, and the conveyance speed (print speed Vc) of the medium 10 on the downstream conveyance path P2 is set to a speed slower than the substantial conveyance speed Vb.

The slack generator 20 is disposed between the upstream conveyance path P1 and the downstream conveyance path P2, the conveyance speed (print speed Vc by the printing section 22) of the medium 10 on the downstream conveyance path P2 is set to a speed slower than the substantial conveyance speed Vb on the upstream conveyance path P1 as described above, and thereby the read/write section 16 can perform the read/write processing for the IC tag 10a without stopping the conveyance of the medium 10 by the printing section 22. Therefore, the occurrence of a printing failure caused by stopping the medium 10 in the printing section 22 can be suppressed.

By calculating the substantial conveyance speed Vb on the basis of the medium failure rate E1 and the read/write error occurrence rate E2, such operation that the read/write section 16 performs the read/write processing without stopping the conveyance of the medium 10 by the printing section 22 can be implemented, in consideration of possibilities of manufacturing defects of the medium 10 and errors of the read/write processing.

By setting the conveyance speed (print speed Vc) of the medium 10 on the downstream conveyance path P2 to a speed that is slower than the substantial conveyance speed Vb and is as close as possible to the substantial conveyance speed Vb, the throughput of the printing system 100 can be improved.

The slack generator 20 generates the slack of the medium 10 if the print length A of the medium 10 is longer than the cutter-section-to-printing-section distance G, and thereby the conveyance of the medium 10 on the downstream conveyance path P2 can be continued when the cutter section 18 stops the medium 10 on the upstream conveyance path P1 to cut the medium 10, and the suspension of the conveyance of the medium 10 in the printing section 22 can be suppressed.

### Second Embodiment

A second embodiment of the present invention will next be described. In the first embodiment described above, the conveyance speed (i.e. print speed Vc) of the medium 10 on the downstream conveyance path P2 is set slower than the substantial conveyance speed Vb on the upstream conveyance path P1.

In some cases, however, the conveyance speed (print speed Vc) of the medium 10 on the downstream conveyance path P2 cannot be made slower than the substantial conveyance speed Vb on the upstream conveyance path P1.

The first of such cases is a case where a lower limit of the print speed Vc of the printing section 22 is faster than the substantial conveyance speed Vb on the upstream conveyance path P1. This can occur for the reason that the medium failure rate E1 or read/write error occurrence rate E2 is high, for example.

The second of such cases is a case where read errors or write errors occur in succession in the read/write section 16, and the substantial conveyance speed Vb suddenly falls below the print speed Vc.

A printing system 100A in this second embodiment is configured to manage these two cases.

### (Control System of Printing System)

FIG. 7 is a block diagram showing the control system of the printing system having an IC tag processing function (hereafter the printing system) 100A in the second embodiment. In FIG. 7, elements identical to the elements of the printing system 100 in the first embodiment are denoted by the same reference numerals. The printing system 100A in the second embodiment includes the elements corresponding to the roll spindle 13 to the printing section 22 (FIG. 1) described in the first embodiment.

As shown in FIG. 7, the printing system 100A in the second embodiment differs from the printing system 100 in the first embodiment in that a cut decision section 121 and a blank-page insertion decision section 122 are added.

The cut decision section 121 is provided to manage the first case described above. The cut decision section 121 stores the lower limit of the print speed Vc. The lower limit of the print speed Vc is determined beforehand in consideration of the electrophotographic process in the printing section 22.

To the cut decision section 121, the substantial conveyance speed Vb calculated by the substantial conveyance speed calculator 109 is sent through the slack amount calculator 105. The cut decision section 121 also stores a maximum value (i.e. largest slack amount) D of the permissible range of the slack amount of the medium 10 in the slack generator 20.

If the print speed Vc cannot be made slower than the substantial conveyance speed Vb, the cut decision section 121 calculates a longest possible value of a print length A1 that satisfies the following expression (3).

$$\frac{D}{Vc - Vb} > \frac{A 1}{Vb} - \frac{A 1}{Vc} \qquad ( 3 )$$

The left side of expression (3) represents a buffer time secured by slackening the medium 10 to the maximum amount D by the slack generator 20. The right side of expression (3) represents a difference in time between the upstream end and the downstream end in the slack generator 20 when the print length is A1 and when the medium 10 is conveyed at the substantial conveyance speed Vb on the upstream conveyance path P1 and at the print speed Vc (preferably the lower limit of the print speed Vc) on the downstream conveyance path P2.

Even if the substantial conveyance speed Vb on the upstream conveyance path P1 is higher than or equal to the conveyance speed (i.e. print speed Vc) on the downstream conveyance path P2, the medium 10 having a length not exceeding the given length (A1) can be conveyed while the slack amount of the medium 10 in the slack generator 20 is being decreased gradually.

The print length A1 obtained from expression (3) is such a length that the medium 10 can be conveyed at the substantial conveyance speed Vb on the upstream conveyance path P1 and at the print speed Vc (>Vb) on the downstream conveyance path P2 while the slack amount of the medium 10 in the slack generator 20 is being decreased gradually.

The cut decision section 121 calculates the print length A1 by expression (3), and sends medium cutting information including the print length A1 to the operating section 101. The operating section 101 receives the medium cutting information from the cut decision section 121, displays a message asking whether cutting the medium 10 to the print length A1 is permitted, and accepts an instruction (a choice of permission or non-permission) of the operator 41. The operating section 101 receives the instruction of the operator 41 and sends information indicating the instruction to the cut decision section 121.

If the cut decision section 121 receives information indicating that cutting the medium 10 to the print length A1 is permitted from the operating section 101, the cut decision section 121 sends a cut instruction to cut the medium 10 to the print length A1, to the print controller 104. If the cut decision section 121 receives information indicating that cutting the medium 10 to the print length A1 is not permitted from the operating section 101, the cut decision section 121 sends a cut instruction to cut the medium 10 to the print length A (FIG. 1) based on the print instruction, to the print controller 104. The print controller 104 sends a cut instruction to the cutter controller 107 according to the cut instruction from the cut decision section 121.

The blank-page insertion decision section 122 shown in FIG. 7 is provided to manage the second case described above. To the blank-page insertion decision section 122, the slack amount of the medium 10 detected by the slack amount calculator 105 is sent from the slack amount calculator 105.

When the slack amount sent from the slack amount calculator 105 approaches zero, the blank-page insertion decision section 122 sends a blank page insertion instruction to the print controller 104.

To insert a blank page is to convey the medium 10 at the substantial conveyance speed Vb on the upstream conveyance path P1 and at the print speed Vc (<Vb) on the downstream conveyance path P2 without performing the read/write processing in the read/write section 16 or printing in the printing section 22. Thus, the read/write processing is not performed for some IC tags 10a included in the medium 10, and a certain range of the medium 10 becomes a blank part where the printing is not performed. The blank page insertion is performed for a predetermined period.

In a case where a succession of errors or the like in the read/write section 16 causes a sudden decrease of the substantial conveyance speed Vb on the upstream conveyance path P1 to a speed slower than the print speed Vc, the slack amount of the medium 10 in the slack generator 20 decreases because the medium 10 is conveyed at the print speed Vc on the downstream conveyance path P2.

So, when the slack amount of the medium 10 in the slack generator 20 approaches 0, the slack amount of the medium 10 in the slack generator 20 is recovered by conveying the medium 10 at the substantial conveyance speed Vb (speed recovered from the sudden decrease) on the upstream conveyance path P1 and at the print speed Vc (<Vb) on the downstream conveyance path P2 without performing the read/write processing and the printing. After the slack amount is recovered, the conveyance of the medium, the read/write processing, and the printing is performed in the same manner described in the first embodiment.

### (Operation of Printing System)

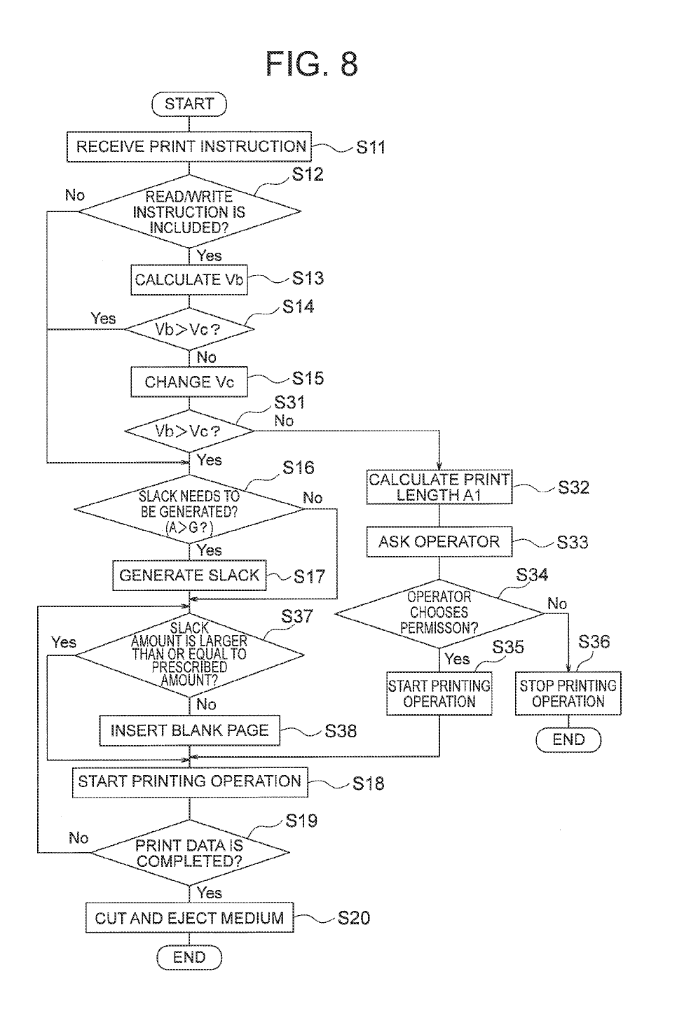

Operation of the printing system 100A will next be described. FIG. 8 is a flowchart illustrating the operation of the printing system 100A. In the flowchart in FIG. 8, step S31 of comparing the substantial conveyance speed Vb and the print speed Vc is added after step S15 of changing the print speed Vc to a speed slower than the substantial conveyance speed Vb. Further, steps S32 to S35 to be performed according to a result of decision in step S31 are also added.

In step S15 described in the first embodiment, the print speed Vc is changed to a speed slower than the substantial conveyance speed Vb, but if the substantial conveyance speed Vb is lower than the lower limit of the print speed Vc, the print speed Vc cannot be changed to a speed slower than the substantial conveyance speed Vb.

In step S31, the cut decision section 121 compares the substantial conveyance speed Vb and the print speed Vc, and if the substantial conveyance speed Vb is still lower than or equal to the print speed Vc, the processing proceeds to step S32.

In step S32, the cut decision section 121 calculates the print length A1 on the basis of expression (3) described above. Then, the operator 41 is asked through the operating section 101 whether cutting the medium 10 to the print length A1 is permitted (step S33) and the operating section 101 accepts a choice of the operator 41 (step S34).

If the operator 41 permits cutting the medium 10 to the print length A1, the cut decision section 121 sends a cut instruction for cutting to the print length A1 to the print controller 104. Then, the print controller 104 starts the printing operation (step S35).

If the operator 41 does not permit cutting the medium 10 to the print length A1, the cut decision section 121 sends an instruction to stop the printing operation (including the read/write processing and the printing) to the print controller 104. Thereby, the print controller 104 stops the printing operation (step S36). The printing operation stops because if the slack amount of the medium 10 in the slack generator 20 becomes zero, it is possible that the conveyance of the medium 10 in the printing section 22 stops, and it is possible that an interruption of the electrophotographic process causes a printing failure to occur.

As for cutting the medium 10 to the print length A1, permission from the operator 41 is obtained in advance because the medium 10 is prevented from being cut to a length which is not intended by the operator 41.

In the flowchart in FIG. 8, before the printing operation (step S18), step S37 of determining whether the slack amount is larger than or equal to a prescribed amount and step S38 of inserting a blank page if the slack amount is smaller than the prescribed amount are added.

In step S37, the blank-page insertion decision section 122 determines whether the slack amount of the medium 10 calculated by the slack amount calculator 105 is larger than or equal to the prescribed amount. This prescribed amount is set to a value close to zero, or a value equal to the slack amount needed for cutting, for example. The reason for setting the prescribed amount to a value equal to the slack amount needed for cutting is to prevent the slack amount from reaching zero in the process of cutting the medium 10, consequently prevent the conveyance of the medium from stopping and prevent a printing failure from occurring.

If the slack amount is determined to be smaller than the prescribed amount, the blank-page insertion decision section 122 sends the blank page insertion instruction to the print controller 104. If the blank page insertion instruction is sent from the blank-page insertion decision section 122, the print controller 104 performs neither the read/write processing nor the printing and has the first medium conveyance motor M1 convey the medium 10 at the substantial conveyance speed Vb on the upstream conveyance path P1 and has the second medium conveyance motor M2 convey the medium 10 at the print speed Vc on the downstream conveyance path P2 (step S38). As described here, the slack amount of the medium 10 in the slack generator 20 is recovered, and thereafter the printing operation is started (step S18). The subsequent operation is the same as described in the first embodiment.

### (Effects of the Second Embodiment)

As has been described above, in the second embodiment of the present invention, if the conveyance speed of the medium 10 on the downstream conveyance path P2 (print speed Vc in the printing section 22) cannot be set to a speed slower than the substantial conveyance speed Vb on the upstream conveyance path P1, such a value of print length A1 that the medium 10 can be conveyed in the printing section 22 without interruption while the slack amount of the medium 10 in the slack generator 20 is being decreased is calculated. Then, the operator 41 is asked whether cutting the medium 10 to the print length A1 is permitted. If the operator 41 permits it, the printing operation (conveyance of the medium 10, read/write processing, and printing) is performed, and the medium 10 is cut to the print length A1. Therefore, the medium 10 can be prevented from stopping in the printing section 22, and printing failures can be suppressed.

Moreover, if the substantial conveyance speed Vb on the upstream conveyance path P1 decreases suddenly and if the slack amount of the medium 10 in the slack generator 20 falls below the prescribed amount, a blank page is inserted. Consequently, the slack amount of the medium 10 in the slack generator 20 is recovered, and then the printing operation (conveyance of the medium 10, read/write processing, and printing) can be started. Therefore, the medium 10 can be prevented from stopping in the printing section 22, and printing failures can be suppressed.

Here, the first operation of cutting the medium 10 to the print length A1 by permission of the operator 41 if the print speed Vc cannot be set to a speed slower than the substantial conveyance speed Vb (countermeasure for the first case) and the second operation of inserting a blank page to recover the slack amount if the slack amount of the medium 10 in the slack generator 20 falls below the prescribed amount (countermeasure for the second case) are performed. However, only one operation of the two operations may be performed.

The invention being thus described, it will be obvious that the same may be varied in many ways. Such variations are not to be regarded as a departure from the spirit and scope of the invention, and all such modifications as would be obvious to one skilled in the art are intended to be included within the scope of following claims.

What is claimed is:

1. A printing system having an IC tag processing function comprising:
a first medium conveyance section that conveys a medium including a plurality of medium sheets each having an IC tag along a first conveyance path;
a second medium conveyance section that conveys the medium that has been conveyed along the first conveyance path, along a second conveyance path;
an IC tag processor that performs reading and writing processing for the IC tag on the first conveyance path;
a printing section that performs printing on the medium on the second conveyance path;
a slack generator disposed between the first conveyance path and the second conveyance path, the slack generator permitting generation of slack of the medium;
a calculator that calculates a substantial conveyance speed of the medium by the first medium conveyance section, on a basis of a length of a single medium sheet having the IC tag, first time needed by the first medium conveyance section to convey the single medium sheet having the IC tag, and second time needed by the IC tag processor to process the IC tag of the single medium sheet; and
a speed determinator that sets a conveyance speed of the medium by the second medium conveyance section to a speed slower than the substantial conveyance speed calculated by the calculator.

2. The printing system according to claim 1, wherein the calculator calculates the substantial conveyance speed on a basis of a failure rate of IC tags included in the medium.

3. The printing system having according to claim 2, wherein the failure rate of the IC tags included in the medium is measured when the medium is produced and shown in a predetermined part of the medium.

4. The printing system according to claim 2, further comprising a setting storage that stores a first default value of the failure rate of the IC tags included in the medium.

5. The printing system according to claim 2, wherein the calculator calculates a first time equivalent of the failure rate of the IC tags, on a basis of the second time needed by the IC tag processor to process the IC tag of the single medium sheet, a number of retries to be made in a case where the processing by the IC tag processor is unsuccessful, the failure rate of the IC tags included in the medium, and a number of the IC tags included in the medium.

6. The printing system according to claim 1, wherein the calculator calculates the substantial conveyance speed on a basis of an occurrence rate of a processing error in the processing of the IC tag processor.

7. The printing system according to claim 6, further comprising a setting storage that stores a second default value of the occurrence rate of the processing error.

8. The printing system according to claim 6, wherein the calculator calculates a second time equivalent of the occurrence rate of the processing error on a basis of the second time needed by the IC tag processor to process the IC tag of the single medium sheet, a number of retries to be made in a case where the processing by the IC tag processor is unsuccessful, the occurrence rate of the processing error on the medium, and a number of the IC tags included in the medium.

9. The printing system according to claim 1, further comprising a length detector that detects the length of the single medium sheet having the IC tag.

10. The printing system having according to claim 9, wherein the length detector detects the length of the single medium sheet having the IC tag by detecting a mark formed on the medium.

11. The printing system according to claim 1, further comprising a cutting section disposed on the first conveyance path, the cutting section cutting the medium to a predetermined length;
wherein if the predetermined length is longer than a distance from the cutting section to the printing section, the slack generator generates the slack of the medium before the IC tag processor and the printing section start operating.

12. The printing system according to claim 11, wherein the first medium conveyance section conveys the medium while the second medium conveyance section is stopping the conveyance of the medium, and thereby the slack generator generates the slack of the medium.

13. The printing system according to claim 11, further comprising a cut decision section that calculates a length to which the medium is cut, on a basis of a maximum slack amount of the medium in the slack generator, the medium conveyance speed by the second medium conveyance section, the substantial conveyance speed calculated by the calculator, if the medium conveyance speed by the second medium conveyance section cannot be set to a speed slower than the substantial conveyance speed calculated by the calculator.

14. The printing system according to claim 13, wherein the cut decision section accepts a choice of an operator concerning cutting the medium to the length.

15. The printing system according to claim 14, wherein if the operator permits cutting the medium to the length, the first medium conveyance section and the second medium conveyance section convey the medium, the IC tag processor performs the processing for the IC tag, the printing section performs the printing on the medium, and the cutting section cuts the medium to the length;
if the operator does not permit cutting the medium to the length, the processing of the IC tag processor and the printing of the printing section is stopped.

16. The printing system according to claim 1, further comprising a slack amount calculator that calculates a slack amount of the medium in the slack generator;
wherein if the slack amount calculated by the slack amount calculator falls below a prescribed amount, the first medium conveyance section and the second medium conveyance section convey the medium without performing the processing by the IC tag processor and the printing by the printing section, and thereby the slack amount of the medium in the slack generator is recovered.

17. The printing system according to claim 1, wherein the IC tag is an RFID tag;
the IC tag processor includes an RFID antenna and performs the reading and writing processing for the IC tag.

18. The printing system according to claim 1, wherein the printing section uses electrophotography to print an image on the medium.
